(19) United States
(12) Patent Application Publication
(10) Pub. No.: US 2011/0074318 A1
(43) Pub. Date: Mar. 31, 2011

(54) DUAL DRIVE ELECTRIC REGENERATOR

(76) Inventor: Jayantha Liyanage, Kurunegala (LK)

(21) Appl. No.: 12/310,055

(22) PCT Filed: Aug. 9, 2006
(86) PCT No.: PCT/IB2006/002217

§ 371 Date: Aug. 23, 2010

(30) Foreign Application Priority Data
Aug. 17, 2005 (LK) 13784
Jul. 7, 2006 (LK) 14153

(51) Int. Cl. H02K 7/02; H02K 53/00

(52) U.S. Cl. 318/161; 74/DIG. 9

(57) ABSTRACT

The dual drive electric regenerator (DDER), an electric power regenerative device in which a heavy driven-backend flywheel combination being coupled directly to the drive shafts of a specially designed electric generator with dual drives. The driven flywheel with magnetic Pole pieces attached to its circumference area being rotated by the magnetic forces imparted from a driver flywheel with magnetic Pole pieces attached to its circumference surface and rotated by an electric driver motor with its speed being controlled electronically. The DDER expends less input power than the output power generated by the flywheel combination and converted to electrical power by the said generator. The initial power to start the motor being derived from an internal battery. A part of the output power generated being used as the input power through recharging the battery continually and the rotational process being sustained by completing a power regenerative cycle.

### FIELD OF THE INVENTION

The invention is about electrical power generation and technically relates to the fields of Applied Physics, Mechanical, Electrical and Electronics engineering.

The advantages over the existing methods are the absence of the requirement of an external power source, the structural simplicity, easy repair and maintenance.

### REFERENCE TO EARLIER APPLICATIONS

This application is related to the following earlier patent applications by the inventor. The Sri Lanka national patent application (amended) No: 13076, dated 17 Dec. 2003 and the international application number PCT/IB2004/001966, dated 9 Jun. 2004.

The following features disclosed in the above two applications have been used in this disclosure with detailed descriptions based on significant improvements.

(01). The feature of using a heavy driven flywheel.
(02). The magnetic repulsion only method.
(03). The most suitable position of the driver flywheel.
(04). The magnetic Pole piece-spacing length ratios.
(05). The speed increase method.

The following features have been disclosed as isolated features in the Sri Lanka patent application (divisional) No: 13784, dated 17 Aug. 2005.

(01). The two-diameter flywheel.
(02). The feature of using a backend flywheel
(03). The dual drive feature.
(04). The modified structural features of the existing generators.
(05). Imparting magnetic forces to the inner circumference.
(06). Imparting magnetic forces to the smaller diameter disc
(07). The guide bearing.

The features disclosed in the sections [03.01] and [03.02] have been incorporated into a unified design in the Sri Lanka patent application No: 14153 dated 7 Jul. 2006 with the following structural and functional features incorporated.

(01). The preferred embodiment.
(02). Magnetic attraction only method
(03). The driver-driven flywheel positioning.
(04). Diameter ratios of the driver-driver flywheels.
(05). Determination the length of a Pole piece.
(06). The de-synchronization control method.

### PRIORITY DOCUMENTS

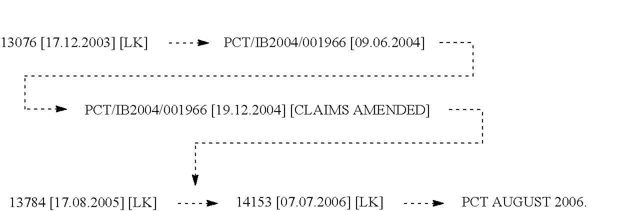

### DESCRIPTION

### Theory

This invention is theoretically linked to the perpetual motion. In the case of the perpetual motion machine, all that is required is some kind of a device that would perpetuate indefinitely without using an external power source in an isolated environment and without doing any useful work.

Helm Holtz in 1847 proposed the law of conservation of energy, which is essentially the first law of thermodynamics and proved for the first time that perpetual motion is not possible. Therefore, it has become an established belief in the field of modern science that the perpetual motion cannot be achieved without violating the law of the conservation of energy.

The Oxford dictionary under perpetual motion states that the perpetual motion machine is as a hypothetical machine running forever unless subject to an external force or wear. Going by this interpretation, one could say that the perpetual motion has been achieved if a device has been constructed in which a wheel rotates in an isolated environment until the device breaks down due to wear and not due to the decline of the energy source that rotates the wheel.

The basic argument behind this is that the amount of input energy used by a device must be equal to the amount of energy transformed by that device to another form (first law of thermodynamics). During this transformation, a certain amount of energy will be wasted due to the frictional forces (second law of thermodynamics) and as a result the amount of input energy that gets transformed into output energy is always less than the input energy used unless a frictionless device could be constructed. Therefore, in order to achieve the perpetual motion, the transformed energy needs to be re-used as the input energy by transforming back into the type of input energy used. Since no material device could avoid waste energy under normal conditions, therefore to achieve the perpetual motion, the transformed energy requires to exceed the input energy used, which is impossible as the law of conservation of energy states.

But one could re-question this argument behind the law of conservation of energy by asking why energy cannot be added during the transformation process to the transformed energy without creating new energy out of nothing while keeping the input energy used as a constant and without any other external energy source being connected to the initial system. This way the transformed energy could be increased during the transformation process and be used as input energy by transforming back into the type of input energy used. If this could be done, then the obstacle pose by the two laws of thermodynamics could be overcome. Therefore, one could summarize this basic argument by saying that to achieve the perpetual motion one has to violate the law of conservation of energy is an erroneous concept held for a very long time. This inventor says that it is possible to increase the amount of transformed energy after the transformation by adding energy during the transformation process therefore without violating the law of conservation of energy.

In the method described in this disclosure, the input energy used has not been amplified nor energy has been created out of nothing. This has been done by a method that utilizes a hitherto undefined energy source in the nature. The energy source that the inventor refers is the lever effect. However, this phenomenon has not being generally recognized as an energy source. In modern science, this energy source has been described merely as an advantage but not as a force. Therefore, from where does this energy come from to give the so-called advantage?

Once this phenomenon has been understood, all that is required is a method to impart a small force continually in a controlled fashion to rotate a relatively heavy flywheel to a high speed. This way the energy being accumulated due to the heavy mass and due to high speed. This is basically what has been achieved in this invention through a very simple structural design.

### DESCRIPTION

### Background

This background description highlights certain modified features in the inventive design. These modifications have been derived by observing the following phenomenon.

The Generator

The word electric generator can be a confusing term as it could mean a complete electric power generating unit or it could mean the current-voltage generating part. But here the generator means AC or DC alternators, permanent magnet generators, synchronous generators etc. The existing types of such generators have been designed mostly to fix in the horizontal position. That means its drive shaft rotates parallel to the ground surface. The shaft diameter of an existing generator has been designed in relation to the power capacity. That is to withstand the retarding forces that get exerted and also depending on the type of power coupling method that normally intended to use with a particular generator. There is no existing generator with a specific power capacity intended to fix in the horizontal position that has been designed with a significantly larger drive shaft together with larger-stronger internal bearings and with a stronger outer casing in comparison to an existing generator with a similar power capacity. For example, there is no existing generator with a power capacity of say 100 watts and having a metal drive shaft with two-inch diameter together with bearings having a two-inch bore and with a strong casing to withstand the rotational force of a driven flywheel that rotates at 1500 R.P.M and having a mass of over a hundred kilograms.

Also the driveshaft of existing generators that is its rotating central armature shaft protrudes only from one side of the outer casing. There is no available generator, in which its central armature shaft protrudes from both sides of the outer casing thereby forming two drive shafts.

The Flywheel

Flywheels are being widely used in various types of machinery and almost all the traditional or the conventional flywheels have two unique features in common that is, its wider-heavier outer rim area with hollow areas in the middle. In this invention, a flywheel has being used but the flywheel used does not include those two features as it has been observed that these two features are potentially unsuitable for the design derived in this invention. The said wider-heavier outer rim causes rotational jerks at the start of rotation, during rotation or when stopping. However, having such jerks during stoppage would not cause much problem but at the start or more seriously during rotation would cause the driver and the driven flywheels to dislodge from each other, the main operational problem that this invention has to deal in order to operate the device successfully. Therefore, these two features have not been used in this design. At the same it has been observed that the opposite features to these features are more suited for the design in this invention. However, the word flywheel has been used to highlight the fact that it is the flywheel that generates output power as the word flywheel has being associated with the idea of accumulating energy. Therefore, it can be highlighted that the flywheel used in this invention is not a traditional one.

The Electric Motor

It is known that electric motors consume a certain amount of current under free rotation and this is especially noticeable in DC motors. When a load is applied to its drive shaft, the consumed current tends to increase depending on the load. It has been observed by the inventor that this average current consumption tends to drops below the free running average current consumption under a certain condition during the rotational process. This observed phenomenon has been used in this invention to design certain electronic circuits for rotational control.

### DESCRIPTION

### Technical

### Mechanical

The Dual Drive Electric Regenerator (DDER).

The dual drive electric regenerator (DDER) is an electric power regenerative device (PRGD), which is capable of generating electric power continually until the device breaks down due to component failures. The DDER generates its own power by rotating a relatively heavy driven-backend flywheel combination to a high speed by magnetic forces expending less input power and by sustaining the power generation through a process of power regeneration (PPRG). This has being achieved by converting the rotational mechanical energy generated by the flywheel combination into electrical power by a specially designed electric generator with two drive shafts, hereinafter called as the dual drive electric generator (DDEG) and thereafter by storage and transfer to reuse as the input power thereby completing a power regenerative cycle (PRGC).

In place of an external power source used in the existing electric generators, the DDER uses magnetic force as an internal power source, which is apparently inexhaustible. This magnetic forces being imparted from a driver flywheel onto the outer circumference area of a driven flywheel as magnetic repulsion force (MRF) or as magnetic attraction force (MAF). In the preferred embodiment of the DDER shown in FIGS. (01) and (02), magnetic force being imparted either as MRF or as MAF to the outer circumference surface of the larger diameter disc of the driven flywheel. There are two other positions in the driven flywheel that these magnetic forces could be imparted. They are the inner circumference surface of the driven flywheel and the outer circumference surface of the smaller diameter disc. To impart magnetic forces to these two positions certain structural modifications required to be done. The main description has being based on the preferred embodiment Therefore, when these variations are being implemented certain methodical changes occur and such changes have been described under the respective description related to those changes.

The preferred embodiment consists of a driven-backend flywheel combination (DBFC) being coupled to the drive shafts of the said DDEG from two opposite ends of the outer casing. The driven flywheel (DVFW) being coupled from one end, namely the front-end as close as possible to the outer casing of the DDEG. The backend flywheel (BEFW) being coupled from the other side namely, the backend. An even number of permanent magnetic Pole pieces being attached to the outer circumference surface of the said larger diameter disc. A driver flywheel (DRFW) with two magnetic Pole pieces attached being fixed as close as possible to the outer circumference surface of the driven flywheel with two outer circumference surfaces are facing and overlapping each other. The magnetic forces being imparted from the magnetic Pole pieces of the driver flywheel onto the magnetic Pole pieces of the driven flywheel while rotating in the opposite directions. The driver flywheel being rotated by an electric driver motor (EDRM) in which a direct current (DC) motor being the preferred one while a stepper motor would also be a suitable candidate. The two flywheels being made to synchronize magnetically with each other by rotating in opposite directions with two different speeds being imitated, in which an external rotational impetus force (RIMPF) being given to the driven flywheel. The magnetic synchronization occurs naturally. Thereafter, the driven flywheel rotates under the influence of the driver flywheel. The speed of the driven flywheel then being increased by increasing the speed of the driver motor-driver flywheel. An electronic control sequence being used to control the rotational process. The initial power to rotate the driver motor being derived from a precharged, high capacity internal battery. The battery thereafter being recharged from part of the power generated by the DDEG. The optimum specifications of the flywheel combination together with the driver motor being determined in relation to the power capacity of the DDEG.

### [Ref—FIGS. (01), (02)—Claim 1].

The Driven Flywheel (DVFW)

The driven flywheel consists of two circular discs with two different diameters with a common center bore. The two discs being preferably joined together but could be forged or machined as a singular block. The two discs being made preferably from mild steel. Cast iron could be used with a steel rim attached to the outer circumference surface (OCFS). Lead alloy would be suitable where a compact DDER is the requirement. The larger diameter disc (LDDC) being fixed as close as possible to the DDEG outer casing. In between the outer casing and the driven flywheel, a very thin metal bush (MBH) [FIG. (08)] being incorporated to the drive shaft to prevent the flywheel being touching the outer casing.

### [Ref:—FIG. (02)—Claim 2].

The Uniform Diameter Driven Flywheel (UDDVFW)

It is also possible to use a driven flywheel with a uniform diameter, but it has been noticed that two diameter disc arrangement offers a much more stable rotation consisting of much higher rotational energy. Therefore, it can be said that this invention uses a flywheel that has opposite features to that of the traditional flywheels.

Magnetic Pole Pieces (MGPP)

Permanent magnetic Pole pieces made from materials such as sintered ceramic ferrites, Neodymium Iron Boron being attached to the outer circumference surface of the larger diameter disc, the smaller diameter disc, the inner circumference surface of the driven flywheel as well as to the outer circumference surface of the driver flywheel. The strength of the magnetic Pole pieces attached to the driver flywheel preferably being with much higher magnetic Pole strength than the Pole pieces attached to the driven flywheel. The magnetic Pole strength required being above three (3) MGOs.

The Backend Flywheel (BEFW)

The backend flywheel consists of two circular discs with two different diameters with a common center bore in its basic form. The larger diameter disc being fixed as close as possible to the DDEG casing with a metal bush incorporated.

The backend flywheel being considered as a passive energy-accumulating device as no external force being imparted to it. The driven flywheel contains magnetic Pole pieces and also a driver flywheel being fixed close to it, therefore its dimensions are somewhat fixed from the beginning of the design. But this is not the case with the backend flywheel. It has no such structural restrictions. Therefore, its dimensions can be adjusted within a reasonable range. This feature would give the initial design stage of the DDER a considerable freedom as the dimensions of the backend flywheel could be varied until the optimum dimensions are being arrived. It has been noticed that by increasing, the circumferential length of the larger diameter disc of the backend flywheel slightly than the driven flywheel's circumferential length seems to increase the system performance. But increasing the circumferential length of the larger diameter disc beyond a certain limit would create other problems such as upsetting the magnetic synchronization capability while increasing the width would cause an undue weight on the drive shaft of the DDEG.

The circumferential lengths (CFL) and the circumferential widths (CFW) of the two discs being varied and adjusted to determine the dimensions of the backend flywheel to generate an optimum amount of output power in conjunction with the driven flywheel in relation to the speed and the power capacity of the DDEG. [Ref:—FIG. (02)—Claim 3]

Magnetic Forces to the Inner Circumference Surface

To impart magnetic forces to the driven flywheel's inner circumference surface (ICFS), a metal rim (MRM) being attached to the inner face of the larger disc of the driven flywheel. Magnetic Pole pieces being attached to the inner circumference surface of the metal rim. The magnetic forces then being imparted from the driver flywheel from inside of the metal rim. When the magnetic forces being imparted from the outer circumference area, then both flywheels rotates in the opposite direction. But when the magnetic force being imparted to the inner circumference, then both the driver and the driven flywheels rotates in the same direction. Therefore, there is a methodical variation when the magnetic Pole pieces being fixed to the inner circumference of the driven flywheel. This condition is true for both magnetic repulsion method as well as magnetic attraction method.

The width of the metal rim attached being approximately equal to the width of a magnetic Pole piece to be attached and the thickness of the rim being reasonably thin but strong enough to withstand the forces exerted and to attach the Pole pieces. The circumference length of the metal rim and the circumference length of the larger diameter disc (LDDC) being preferably of same length. Decreasing the circumferential length of the rim would gain a higher speed to the driven flywheel at the expense of the input power requires to be expended. Increasing it would create the opposite conditions.

This arrangement would have an advantage under certain circumstances such as where a compact design of the DDER is required that is the outer structural casing required to be reduced. [Ref:—FIGS. (03), (04)—Claim 4]

The Guide Bearing

To prevent the rotational swing of either driven or the backend flywheel at high speeds, a guide bearing (GDBG) being used. The outer end of the drive shaft being tapered and inserted into the center ring of a bearing preferably a relatively small ball bearing and being adjusted finely to an extent that the tapered end (TPE) would only slightly touches or with touch or no touch situation to the center ring of the bearing that means it would not enforce any weight so as to cause any frictional losses. If the said tapered end begins to touch the said center ring at high rotational speed then it would become the ideal adjustment. Such unnecessary losses would affect the efficiency significantly. This type of guide bearing is required because the use of a heavy flywheel combination would damage the internal bearings of the DDEG, then it would also damage other parts as well. All this will reduce the life span of the device.

### [Ref:—FIG. (05)—Claim 5].

Imparting Magnetic Forces to the Smaller Diameter Disc

To impart the magnetic forces to the driven flywheel's smaller diameter disc (SDDC) from the outer face of the driven flywheel, the preferred embodiment being restructured. Permanent magnetic Pole pieces being attached to the outer circumference surface of the said smaller diameter disc. The driver flywheel together with the electric driver motor being fixed to the structural support, which holds a guide bearing from the outer face of the said SDDC of the driven flywheel. A suitable arrangement being, in which the center of the driver flywheel coincides with the outer circumference surface of the smaller diameter disc of the driven flywheel.

This arrangement would be useful under certain circumstances. That is where the fixing of the driver flywheel from the outer face is convenient in terms of repair and maintenance, fixing of a guide bearing is imperative, the speed of the driver motor requires to be compromised.

### [Ref:—FIG. (05)—Claim 6].

The Fixing Position for the Driver Flywheel

The outer circumference surfaces of the driver and the driven flywheels with magnetic Pole pieces attached being placed parallel to each other along the circumference surfaces. The driver flywheel being adjusted sideways if required across the surfaces to locate the position in which the field forces of the opposing magnetic Pole pieces would interact with each other in the strongest possible way, that is to locate the field force concentration position. The driver flywheel then being fixed, in which the outer surfaces of the magnetic Pole pieces would sweep each other during rotation as close as possible but would not touch each other at the highest intended speed. A gap of 1 to 2 millimeters would be acceptable. [Ref:—FIG. (06)—Claim 7].

The Specific Position for the Driver Flywheel

The driver flywheel being fixed at a specific position (SP) around the driven flywheel's outer circumference surface. When viewed from the driven flywheel's outer face, the specific position being in the middle area of the left bottom quadrant. This specific position being located by drawing a horizontal line from the center of the drive shaft towards left between the top and bottom left quadrants until it reaches the surface of a Pole piece attached to the circumference. Thereafter by drawing a perpendicular line downward from there to the center of the driver flywheel. There are three other suitable specific positions around the driven flywheel's circumference. This specific position is also valid for the driver flywheel that has being fixed from inside but the procedure of locating the position needs redefining. [Ref:—FIG. (07)—Claim 8].

The Dual Drive Electric Generator (DDEG)

The dual drive electric generator (DDEG) consists of a rotating central armature shaft that protrudes from two opposite sides of the outer casing thereby forming two drive shafts. The diameter and the length of the two shafts, the casing thickness, the dynamic loading figure of the internal bearings being determined to withstand the force that enforces at a determined speed by the flywheel combination that has being coupled to generate an amount of rotational mechanical power equivalent to the power capacity of the DDEG or to part of it. A rough guide would be to keep the drive shaft diameter and the diameter of the center bore of the internal bearings of same length or the center bore diameter being slightly smaller as then it would nicely fits into the two sides from inside. The dynamic loading figure can be calculated from the static loading figure given by the manufacture once the rotational speed of the flywheel combination being determined. The dimensions of the flywheel combination, which include the disc diameters and widths together with its total mass being determined in relation to the power capacity of the DDEG. [Ref:—FIG. (08)—Claim 9].

The Diameter Ratio of the Driver-Driven Flywheels.

In order to generate a useful amount of output power from the driven flywheel, the effective ratio range of the driver flywheel diameter to that of the driven flywheel's larger diameter disc requires being between two and three to ten and twenty [(2-3):(10-20)]. This ratio being adjusted to determine the optimum diameter ratio in relation to the speed of the electric driver motor with or without a speed increase mechanism is being incorporated. However, the rotational process itself would work well outside this range. [Ref:—Claim 10]

The Power Capacity of the Driver Motor

The power capacity of the electric driver motor being determined in relation to the maximum input power requires to be expended to rotate the driven-backend flywheel combination to generate a determined amount of output power in relation to the power capacity of the chosen DDEG. The power capacity of the motor being determined to be slightly higher than the input power requires to be expended by the motor. This is a critical factor because any unnecessary waste of power in the motor would affect the overall efficiency. [Ref:—Claim 11].

The Number of Pole Pieces to be Attached to the Driven Flywheel.

The number of Pole pieces require to be attached to achieve magnetic synchronization must always be an even number. This even number is a specific even number for a given circumferential length of a driven flywheel. In this arrangement, magnetic Pole pieces with same type of Poles that is either North Poles or South Poles protruding outwardly and parallel to the circumference surface of the driven flywheel being attached consecutively with equal spacing between the Pole pieces. The length of the spacing being approximately twice the length of a Pole piece. The said specific even number being determined in relation to the circumferential length of the driven flywheel and from the condition that ensures the magnetic synchronization with the driver flywheel, in which the optimum rate of speed varying capability being achieved. Here the optimum means the speed-varying rate being not too slow in comparison to a condition that speed could be varied at a much faster rate. Therefore, it means a middle range. By adding two more Pole pieces to the said determined number would ensure the condition of stronger magnetic synchronization with lower speed varying capability. By deducting two Pole pieces from the said determined even number would ensure weak magnetic synchronization with faster speed increase capability. The spacing between the Pole pieces then will have to be readjusted. However, the use of the said determined number is recommended. [Ref:—FIGS. (09), (10)—Claim 12].

The Magnetic Repulsion Only Method (MROM).

The said magnetic forces can be imparted as magnetic repulsion only force. A magnetic Pole piece attached to the driver flywheel imparts magnetic repulsion force onto the magnetic Pole pieces attached to the driven flywheel from a lagging position relative to the direction of rotation of the driven flywheel. The magnetic Pole pieces being attached to the driver and the driven flywheels consecutively along the circumference surface with same type of Pole faces that either North Poles or South Poles protruding outwardly and parallel to the said circumference surfaces. [Ref:—FIG. (09)—Claim 13].

The Magnetic Attraction Only Method (MROM)

The magnetic forces can be imparted as magnetic attraction only force. A Pole piece attached to the driver flywheel exerts magnetic attraction force from the Pole pieces attached to the driven flywheel from a leading position relative to the direction of rotation of the driven flywheel. Same type of Poles being attached to the driven flywheel consecutively to the circumference surface with equal spacing while opposite type of Pole pieces to that of the Pole pieces attached to the driven flywheel being attached to the driver flywheel circumference surface consecutively. [Ref:—FIG. (10)—Claim 14]

Determining the Length of a Magnetic Pole to be Attached.

The length of a magnetic Pole piece to be attached being initially determined from the circumferential length of the chosen driver flywheel. For a chosen driver flywheel circumference surface, two magnetic Pole pieces with same type of Poles faces, that is either North Poles or South Poles protruding outwardly and parallel to the circumferential surface being attached with equal spacing between the Pole pieces. The length of a Pole piece being approximately one quarter length [¼] of the circumferential length when measured from the bottom surface of the magnetic Pole piece that has being attached to the circumference surface of the driver flywheel. Therefore, the ratio of a Pole piece length to that spacing length being approximately one to one [1:1]. This Pole piece length could be increase slightly but not the spacing length. The circumferential length of the driver flywheel depends on the diameter of the chosen driven flywheel. The diameter together with other specifications of the driven flywheel depends on the rotational mechanical requires to be generated. This figure depends on the chosen power capacity of the DDEG. The ratio of the driver flywheel diameter to that of the driven flywheel being finally determined from the effective ratio range given [section 06]. [Ref:—Claim 15]

The Length Ratio of Magnetic Pole Pieces Attached

The ratio of a length of a magnetic Pole piece attached to the driven flywheel to that of a magnetic Pole piece attached to the driver flywheel being approximately one to one [1:1]. A marginal increase of the length of a Pole piece attached to the driver flywheel would not affect the performance significantly but by decreasing it would. [Ref:—Claim 16]

### DESCRIPTION

### Technical

### Electronic

The Electronic Control Sequence (ECS)

To start the said electronic control sequence (ECS), the driver flywheel first being made to rotate by rotating the electric driver motor to a pre-determined initial speed (PDIS) necessary for magnetic synchronization (MGSY) to occur with the driven flywheel. The driven flywheel then being made to rotate by giving a rotational impetus force (RIMPF) for it to rotate to a higher speed than the speed requires for the said magnetic synchronization. The driven flywheel thereafter being allowed to slowdown until the said magnetic synchronization occurs naturally. The speed of the driver motor then being increased until the driver motor reaches a pre-determined upper speed (PDUS). Electronic circuits being used to set the said initial speed, the said upper speed, to start the automatic speed increase process and to control any magnetic desynchronization (MDSY) that could occur any time during the rotation. The rotational direction of the driven flywheel depends on the fixed position of the driver flywheel.

### [Ref:—Claim 17].

The Speed Varying Method

The said speed increase to the driver motor being done by an automatic speed control circuit (ASCC) from a set pre-determined initial speed to a set pre-determined upper speed. A specific amount of speed being added to the said pre-determined initial speed during a pre-determined time period (PDTP) and being continued to add the speed that way to the motor until the said upper speed being reached, which determines the required speed of the driven flywheel. The said pre-determined initial speed being set by an initial voltage setting circuit (IVSC), the said pre-determined upper speed being set by an upper voltage setting circuit (UVSC). The speed increase process being initiated to the automatic speed control circuit through a starter circuit (STC) when the two flywheels magnetically synchronized. [Ref: FIGS. (11), (12)—Claim 18].

The Magnetic Desynchronization (MDSY) Control Method

For the said magnetic desynchronization that could occur between the driver and the driven flywheels during rotation at any time, the average current consumption (AVCC) by the driver motor when the two flywheels are magnetically synchronized being measured continually by the average current consumption measuring circuit (ACCMC) for any sudden current consumption drop below the said measured average current consumption (MACC). When such a drop occurs, then the driver motor speed being set automatically to the said pre-determined initial speed (PDIS) by the desynchronization control circuit (DSCC) through the initial voltage setting circuit (IVSC) and maintained until magnetic synchronization occurs again. When the two flywheels get synchronized again, then the speed increase process being initiated by the desynchronization control circuit through the starter circuit (STC) to the automatic speed control circuit (ASCC). This process being continued until the said pre-determined upper voltage (PDUV) being reached. The said pre-determined upper voltage being set by the said pre-determined upper voltage setting circuit. This circuit continually compare its setting with the setting of the automatic speed control circuit until the setting becomes equal. When the setting becomes equal, then it initiates a signal to the said ASCC to stop the speed increase process or the voltage increase process. Desynchronization could occur due to a sudden jerk to the device, abrupt voltage variations to the driver motor or due to a sudden increase of the applied load. [Ref:—FIG. (13)—Claim 19].

### DETAILS OF THE DRAWING

Figures show the main components of the preferred embodiment with two structural variations and presented herein for the purpose illustration and description only. Diagrams are not drawn to a scale, but drawn to highlight the main features

The arrow—→—represents to an item.
The arrow— [symbol] —represents a direction, power, signal or a length.
The arrow— [symbol] —represents magnetic field forces.

FIG. (01)

| | | |
|---|---|---|
| DVFW | Driven flywheel. | Figure (01) shows the pictorial representation of the |
| BEFW | Backend flywheel | preferred embodiment of the DDER without its outer |
| DDEG | Dual drive electric generator | structural casing. The skeletal structure of the DDEG |
| DRFW | Driver flywheel. | is shown. |
| EDRM | Electric driver motor | |

FIG. (02)

| | | |
|---|---|---|
| DVFW | Driven flywheel | Figure (02) shows the preferred |
| BEFW | Backend flywheel | embodiment from its front side, |
| MGPP | Magnet Pole piece | which is the operating side |
| DDEG | Dual drive electric generator | of the device. |
| DRSH | Drive shaft | |
| STSP | Structural support | |
| DRFW | Driver flywheel | |
| EDRM | Electric driver motor | |
| ECC | Electronic control circuits. | |
| IBT | Internal battery. | |

FIG. (03)

| | | |
|---|---|---|
| DVFW | Driven flywheel | Figure (03) shows how a metal rim being attached |
| BEFW | Backend flywheel | to the inner face of the driven flywheel. |
| MRM | Metal rim | The magnetic Pole pieces being attached to the inner |
| DDEG | Dual drive electric generator | circumference surface of the metal rim to which |
| DRSH | Drive shaft | magnetic forces being imparted from the driver |
| STSP | Structural support | flywheel from inside. |
| DRFW | Driver flywheel | |
| EDRM | Electric driver motor | |
| ECC | Electronic control circuits. | |
| IBT | Internal battery. | |

FIG. (04)

| | | |
|---|---|---|
| MRM | Metal rim. | Figure (04) shows the metal rim with magnetic Pole |
| OCFS | Outer circumference surface | pieces attached to its inner circumference surface. |
| MGPP | Magnetic Pole piece | The driver flywheel with two North Pole pieces |
| ICFS | Inner circumference surface | attached shown. The driver flywheel being fixed |
| DRSH | Drive shaft | from inside. Driver and the driven flywheels |
| NP | North Pole | rotates in the same direction. |
| DRFW | Driver flywheel | |

FIG. (05)

| | | |
|---|---|---|
| LDDC | Large diameter disc | Figure (05) shows the arrangement in which magnetic |
| SDDC | Small diameter disc | Pole pieces being attached to the smaller diameter disc. |
| GDBG | Guide bearing | The electric driver motor together with the driver |
| TPE | Tapered end. | flywheel being fixed from the outer face of the driven |
| MGPP | Magnetic Pole pieces. | flywheel. The guide bearing assembly is also shown. |
| DRSH | Drive shaft | The magnetic forces being imparted to the smaller |
| EDRM | Electric driver motor. | Diameter disc. |
| STSP | Structural support | |

FIG. (06)

| | |
|---|---|
| DVFW | Driven flywheel. |
| FFCN | Field force concentration. |
| MGFF | Magnetic field forces. |
| DRFW | Driver flywheel. |
| EDRM | Electric driver motor. |
| SDAD | Sideways adjustment. |

Figure shows how driver-driven flywheels being fixed in a facing-overlapping position. The driver flywheel being adjusted sideways to locate the strongest field force concentration (FFCN) position of two opposing magnetic Pole pieces.

FIG. (07)

| | |
|---|---|
| DVFW | Driven flywheel |
| DDEG | Dual drive electric generator |
| DRSH | Drive shaft. |
| SP | Specific position. |
| DRFW | Driver flywheel. |
| EDRM | Electric driver motor. |
| STSP | Structural support. |

Figure shows how driver-driven flywheels being fixed in a specific position when viewed from the outer face of the driven flywheel.

FIG. (08)

| | |
|---|---|
| OCS | Outer casing. |
| IBG | Internal bearing |
| DRSH | Drive shaft |
| MBH | Metal bush |
| ARWD | Armature winding |
| FLWD | Field winding. |

Figure shows the rotating central armature shaft with the core winding. The central shaft protruding out from the internal bearings forms two drive shafts from two sides of the outer casing.
Note the relative sizes of the armature core and the bearing.

FIG. (09)

| | |
|---|---|
| DVFW | Driven flywheel. |
| DR (CW) | Direction of rotation (Clockwise) |
| DRSH | Drive shaft. |
| PMGP (N) | Passing magnet piece (North Pole). |
| MGFF | Magnetic field forces |
| DRFW | Driver flywheel |
| DR (ACW) | Direction of rotation (Anti Clockwise) |
| IMGP (N) | Incoming magnet piece (North Pole). |

Figure shows how magnetic repulsion forces being imparted from the driver flywheel to the driven flywheel.

FIG. (10)

| | | |
|---|---|---|
| DVFW | Driven flywheel. | Figure (10) shows how magnetic attraction |
| DR (CW) | Direction of rotation (Clockwise). | forces being imparted from the driver flywheel |
| DRSH | Drive shaft. | onto the driven flywheel. |
| PMGP (N) | Passing magnet piece (North Pole). | |
| MGFF | Magnetic field forces | |
| DRFW | Driver flywheel | |
| DR (ACW) | Direction of rotation (Anti clockwise) | |
| IMGP (N) | Incoming magnet piece (North Pole). | |

FIG. (11)

The Time Vs. Speed graph shows how a specific amount of speed being increased during a pre-determined time period (PDTP). Initially the speed being set to IS, the initial speed of the driver motor-driver flywheel. This is in fact at time zero or at the initial time (IT). Thereafter, during a time period of IT-IA, the speed being increased from IS-IA. This is actually done by increasing a specific amount of input voltage to the driver motor during the said time period. This process thereafter being continued that way until the desired speed of the driven flywheel being achieved.

FIG. (12)

| | | |
|---|---|---|
| IBT | Internal battery | Figure (12) shows the electronic circuits as |
| SW | Switch | functional block diagrams that has being |
| VVRC | Variable voltage regulator circuit. | used to increase the speed of the driver motor. |
| ASCC | Automatic speed control circuit | |
| EDRM | Electric driver motor | |
| STC | Starter circuit. | |
| IVSC | Initial voltage setting circuit. | |
| UVSC | Upper voltage setting circuit. | |
| XS | External signal | |

FIG. (13)

| | | |
|---|---|---|
| IBT | Internal battery | Figure (13) shows the electronic circuits as |
| SW | Switch | functional block diagrams that has being |
| VVRC | Variable voltage regulator circuit. | used for desynchronization control. |
| ASCC | Automatic speed control circuit | |
| EDRM | Electric driver motor. | |
| STC | Starter circuit. | |
| IVSC | Initial voltage setting circuit | |
| UVSC | Upper voltage setting circuit. | |
| DSCC | De-synchronization control circuit. | |
| ACCMC | Automatic current consumption measuring circuit | |

### THE ELECTRONIC CIRCUIT MODULES

### REF:—[FIG (12) AND FIG (13)]

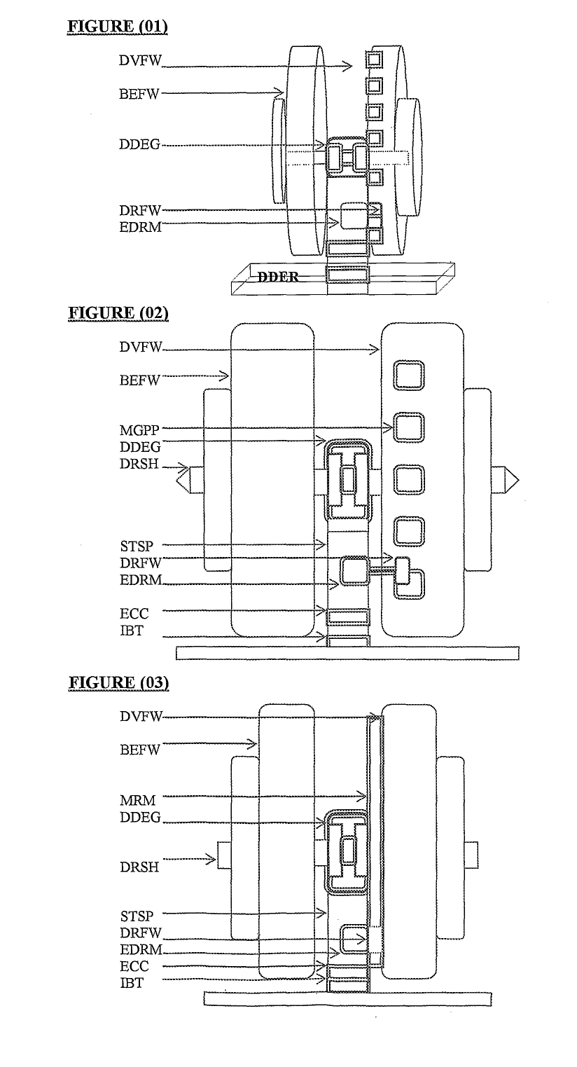

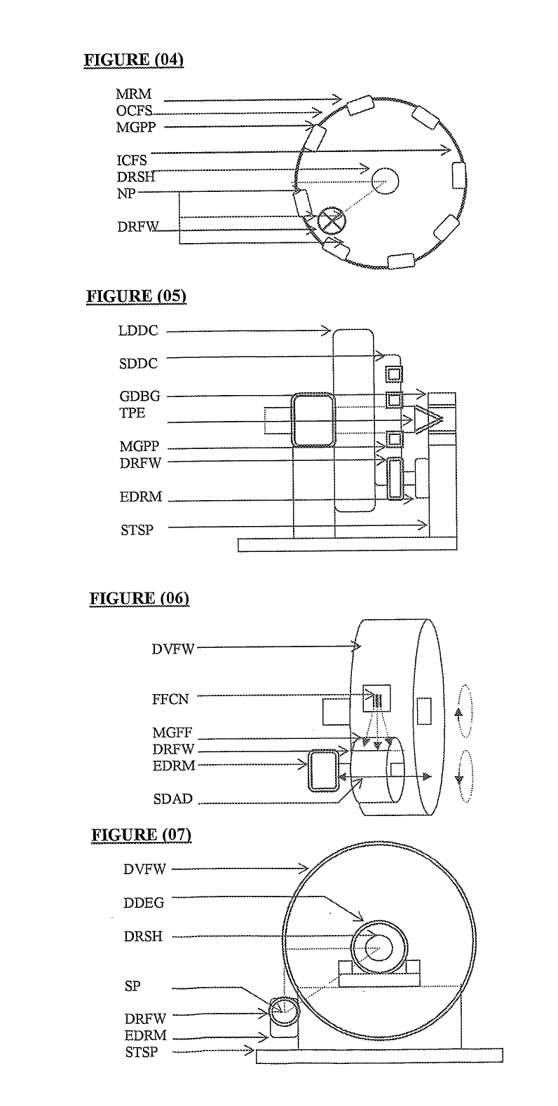

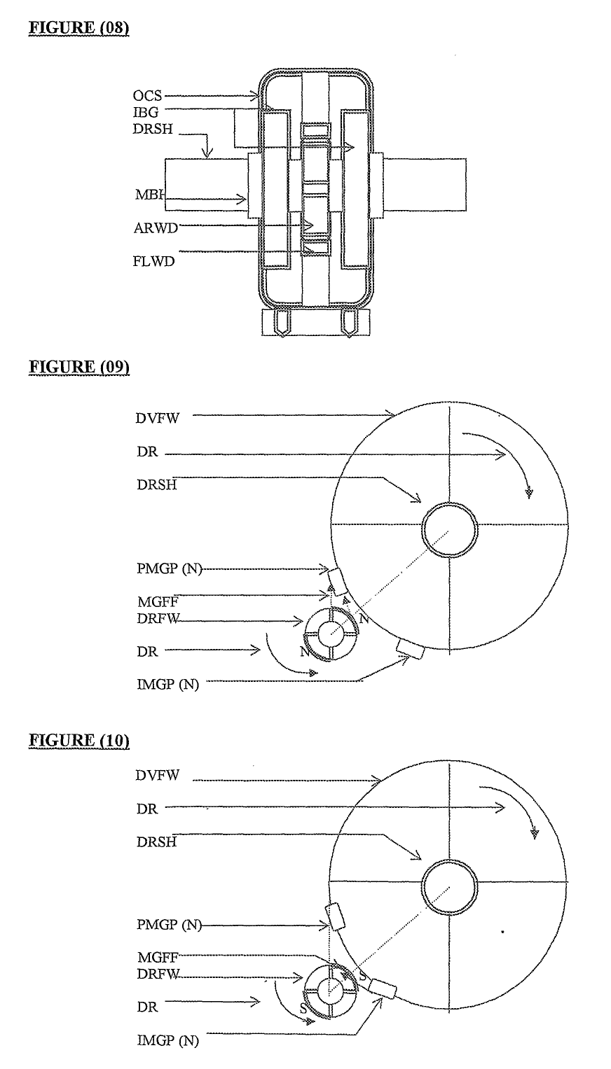

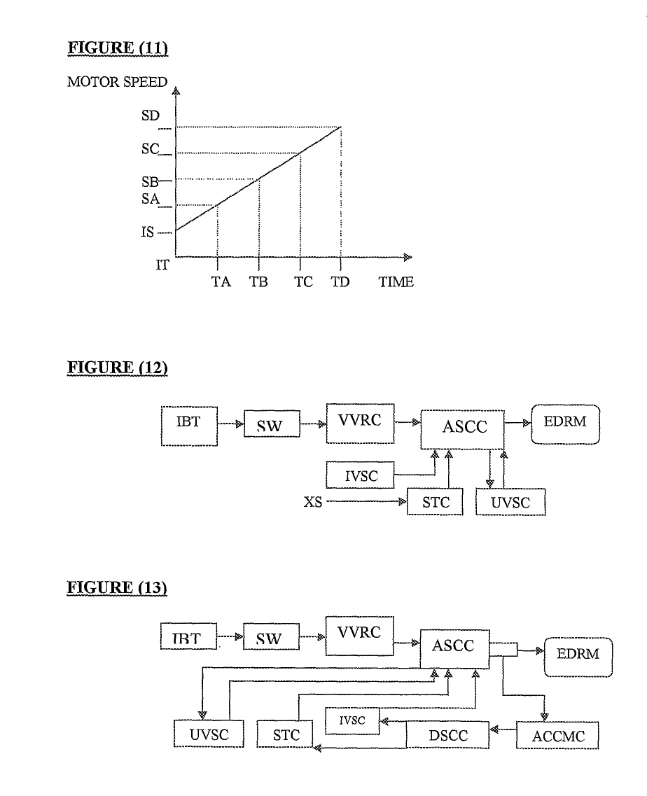

The electronic circuits modules described in the sections 07.02 (FIG. 12) and 07.03 (FIG. 13) have been described in terms of their basic functions in the form of block diagrams and as separate functions regarding the said electronic control sequence in order to simplify the description. In practice the two functions have been combined together to form a single functional module and to do that further minor functional circuits will be required to add to the described basic circuit modules.

### INTERPRETATION

(01). Power regeneration (PRG):—Power regeneration means generating continuous output power by reusing part of the generated output power as the input power through conversion, storage and transfer.
(02). Process of power regeneration (PPRG):—Process of power regeneration means the process in which the power regeneration being achieved.
(03). Power regenerative device (PRGD):—Power regenerative device means the device in which the power regeneration being achieved.
(04). Power regenerative cycle (PRGC):—Power regenerative cycle is as follows—Prime power in the form of storage power in the battery and the initial impetus force—generated rotational mechanical power-conversion to electrical power-storage—reuse as input energy.
(05). Dual Drive Electric Regenerator (DDER):—Dual drive electric regenerator means the device that uses a dual drive electric generator to convert the rotational mechanical energy generated by a driven-backend flywheel combination to electrical power and sustains a power regenerative cycle.
(06). Dual Drive Electric Generator (DDEG):—Dual drive electric generator means an electric generator which consists of a rotating central armature shaft that protrudes from two opposite sides of the outer casing thereby forming two drive shafts.
(07). Driven Flywheel (DVFW):—Driven flywheel means a relatively heavy, two diameter circular flat disc with a center bore and without the traditionally used wider-heavier outer rim area and any hollow areas in the middle of the flat surface.
(08). Backend Flywheel (BEFW):—Backend flywheel means a relatively heavy, two diameter circular flat disc with a center bore and without the traditionally used wider-heavier outer rim area and any hollow areas in the middle flat surface and being used as an energy accumulating and as a rotational balancing flywheel in combination with a driven flywheel.
(09). Driver Flywheel (DRFW):—Driver flywheel means a relatively smaller circular flat disc in comparison to the driven flywheel used and to which the magnetic Pole pieces being attached to its outer circumference area and rotated by an electric driver motor.
(10). Drive shaft (DRSH):—Drive shaft means the metal rod that protrudes from the outer casing of an electric generator to which an external force being applied to rotate it.
(11). Magnetic field forces (MGFF):—Magnetic field forces means the forces that manifest when two permanent magnetic Pole pieces brought near to each other as attraction or as repulsion forces.
(12). Magnetic Pole piece (MGPP):—Magnetic Pole piece means a magnet that has been constructed to attach along the circumference area of a circular disc in which a particular Pole protrudes outwardly relative to the surface of the circumference surface and with a substantial surface area relative to the circumferential width of the disc.
(13). Pole piece:—A Pole piece means a magnetic Pole piece
(14). Magnetic synchronization (MGSY):—Magnetic synchronization means the magnetic Pole pieces that have been attached to the circumference areas of two circular discs interact with each other while rotating in opposite directions in which the speed of the driven disc could be controlled by controlling the speed of the driver disc.
(15). Internal battery (IB):—Internal battery means an ordinary high capacity battery that has been installed within the structure of the DDER.

1. The dual drive electric regenerator (DDER), an electric power regenerative device, in which a driven and a backend flywheel combination being coupled directly to the drive shafts of an electric generator with two drive shafts hereinafter called as the dual drive electric generator (DDEG), the said driven flywheel being attached with an even number of permanent magnetic Pole pieces to its circumference area and being rotated by the magnetic forces imparted from a driver flywheel with two magnetic Pole pieces attached to its outer circumference surface, the said driver flywheel being rotated by an electric driver motor, to start the rotational process, to achieve magnetic synchronization between the said flywheels and to vary their speeds, an electronic control sequence being used, the initial power to rotate the driver motor being derived from a battery, an external rotational impetus force being given to the driven flywheel, the battery thereafter being recharged by using part of the power generated by the said DDEG, the total input power expended by the DDER being less than the total output power generated by the DDER, the specifications of the said driver, driven, backend flywheels and the driver motor being derived in relation to the specifications of the DDEG.

2. The dual drive electric regenerator according to claim 1, in which the said driven flywheel consists of two circular discs with two different diameters joined together, the larger diameter disc being fixed as close as possible to the said DDEG outer casing from one end namely the front end, the said magnetic Pole pieces being attached to the outer circumference surface to which the said magnetic forces being imparted from the said driver flywheel with reference to FIG. (02).

3. The dual drive electric regenerator according to claim 1, in which the said backend flywheel consists of two circular discs with two different diameters joined together, the larger diameter disc being fixed as close as possible to the said DDEG outer casing from one end, namely the backend, in which the circumferential lengths and the widths of the two discs being varied to determine the dimensions that generates the optimum output power in conjunction with the driven flywheel in relation to the speed and the power capacity of the said DDEG.

4. The dual drive electric regenerator according to claim 1, in which to impart magnetic forces to the inner circumference surface of the driven flywheel, a metal rim being attached to the inner face of the larger diameter disc of the driven flywheel, the said magnetic Pole pieces being attached to the inner circumference surface of the said metal rim to which the said magnetic forces being imparted from the said driver flywheel that has being fixed from inside of the metal rim, with references to FIG. (03) and FIG. (04).

5. The dual drive electric regenerator according to claim 1, in which to prevent the rotational swing of the said driven flywheel or the said backend flywheel at high speeds, a guide bearing being fixed, in which the outer ends of the said two drive shafts being tapered and inserted into the center rings of two bearing from two ends to an extent that the said tapered end slightly touches the said center rings thereby not enforcing any weight so as to cause any frictional losses.

6. The dual drive electric regenerator according to claim 1 and to claim 5, in which to impart the said magnetic forces to the said driven flywheel's smaller diameter disc, magnetic Pole pieces being attached to the outer circumference surface of the said smaller diameter disc, the said driver motor together with the driver flywheel being fixed to the structural support which holds the said guide bearing, with reference to FIG. (05).

7. The dual drive electric regenerator according to claim 1, in which the circumference surfaces of the driver and the driven flywheels with magnetic Pole pieces attached being placed parallel to each other along the circumference surfaces, the driver flywheel thereafter being adjusted sideways across the driven flywheel's circumference surface to locate the position in which the field forces of the opposing magnetic Pole pieces would interact with each other in the strongest possible way, the driver flywheel then being fixed, in which the outer surfaces of the said magnetic Pole pieces sweep each other during rotation as close as possible but would not touch each other at the highest intended speed.

8. The dual drive electric regenerator according to claim 1, in which the said driver flywheel being fixed at a specific position around the driven flywheel's outer circumference surface, when viewed from the driven flywheel's outer face, the said specific position being in the middle area of the left bottom quadrant and being located by drawing a horizontal line from the center of the driven flywheel towards left between the top-bottom left quadrants until it reaches the surface of a magnetic Pole piece attached to the circumference surface, thereafter by drawing a perpendicular line downward from there to the center of the driver flywheel, with reference to FIG. (07).

9. The dual drive electric regenerator according to claim 1, the said dual drive electric generator consists of a rotating central armature shaft that protrudes from two opposite sides of the outer casing thereby forming two drive shafts, in which the diameter of the said two shafts, the casing thickness, the dynamic loading figure of the internal bearings being determined to withstand the force that enforces at a determined speed by a flywheel combination that has being coupled to generate an amount of rotational mechanical energy equivalent to the power capacity of the said DDEG or to part of it.

10. The dual drive electric regenerator according to claim 1, in which the effective ratio range of the driver flywheel diameter to that of the driven flywheel's larger diameter disc being between two and three to ten and twenty [(2-3):(10-20)], the said ratios being adjusted to determine the optimum diameter ratio in relation to the speed of the electric driver motor with or without a speed increase mechanism being incorporated, effective means the effective output power that could be generated.

11. The dual drive electric regenerator according to claim 1, in which the power capacity of the said electric driver motor being determined in relation to the maximum input power requires to be expended to rotate the said driven-backend flywheel combination in order to generate a determined amount of output power in relation to the power capacity of the DDEG, in which the power capacity of the said electric driver motor being determined to be slightly higher than the said input power requires to be expended.

12. The dual drive electric regenerator according to claim 1, the said even number being a specific even number, in which magnetic Pole pieces with same type of magnetic Poles protruding outwardly and parallel to the circumference surface of the driven flywheel being attached consecutively with equal spacing between the Pole pieces, the said spacing length being approximately twice the length of a Pole piece attached, the said specific even number being determined in relation to the circumferential length of the driven flywheel and from the condition that ensures the magnetic synchronization with the driver flywheel, in which the optimum rate of speed varying capability being achieved.

13. The dual drive electric regenerator according to claim 1, the said magnetic forces being imparted as magnetic repulsion force, in which a magnetic Pole piece attached to the said driver flywheel imparts magnetic repulsion force onto the magnetic Pole pieces attached to the said driven flywheel from a lagging position relative to the direction of rotation of the driven flywheel, in which magnetic Pole pieces being attached to the driver and the driven flywheels consecutively along the circumference surface with same type of Pole faces protruding outwardly and parallel to the circumference surfaces.

14. The dual drive electric regenerator according to claim 1, the said magnetic forces being imparted as magnetic attraction only force, in which a Pole piece attached to the said driver flywheel exerts magnetic attraction force from the Pole pieces attached to the driven flywheel from a leading position relative to the direction of rotation of the driven flywheel, in which same type of Poles being attached to the driven flywheel consecutively to the circumference surface while opposite type of Pole pieces to that of the Pole pieces attached to the driven flywheel being attached to the driver flywheel circumference surface consecutively.

15. The dual drive electric regenerator according to claim 1 and to claim 10, the length of a magnetic Pole piece to be attached being determined from the chosen circumferential length of the driver flywheel, in which two magnetic Pole pieces being attached with equal spacing between the Pole pieces, the length of a Pole piece attached then being approximately one quarter length [¼] of the circumferential length when measured from the bottom surface of the Pole piece that has being attached to the circumference surface of the said driver flywheel.

16. The dual drive electric regenerator according to claim 1, and to claim 15, in which the ratio of a length of a magnetic Pole piece attached to the said driver flywheel to that of a magnetic Pole piece attached to the said driven flywheel being approximately one to one [1:1].

17. The dual drive electric regenerator according to claim 1, in which to start the said electronic control sequence, the driver flywheel first being made to rotate by rotating the said driver motor to a pre-determined initial speed necessary for magnetic synchronization to occur with the said driven flywheel, the driven flywheel then being made to rotate by giving a rotational impetus force for it to rotate to a higher speed than the speed required for the said magnetic synchronization, the driven flywheel thereafter being allowed to slowdown until the said magnetic synchronization occurs naturally, the speed of the driver motor then being increased until the driver motor reaches a pre-determined upper speed, electronic circuits being used to set the said initial speed, to set the said upper speed, to start the automatic speed increase process and to control any magnetic desynchronization that could occur during rotation.

18. The dual drive electric regenerator according to claim 1 and to claim 17, in which the said speed increase of the driver motor being done by an automatic speed control circuit from a set pre-determined initial speed to a set pre-determined upper speed, a specific amount of speed being added to the said set initial speed during a pre-determined time period and being continued to add the speed that way to the driver motor until the said set upper speed being reached, which determines the required speed of the said driven flywheel, the said initial speed, the said upper speed being set by voltage setting circuits, the speed increase process being initiated to the said automatic speed control circuit through a starter circuit when the said two flywheels magnetically synchronized with each other.

19. The dual drive electric regenerator according to claim 1 and to claim 17, in which for magnetic desynchronization that could occur between the driver and the driven flywheels during rotation, the average current consumption by the said driver motor when the two flywheels are magnetically synchronized being measured continually by the average current consumption measuring circuit for any sudden current consumption drop below the said measured average current consumption, when such a drop occurs, then the driver motor speed being set automatically to the said pre-determined initial speed by the desynchronization control circuit through the initial voltage setting circuit and maintained until magnetic synchronization occurs again, when the two flywheels get synchronized again, then the speed increase process being initiated by the desynchronization control circuit through the starter circuit to the automatic speed control circuit.
